(19) United States
(12) Patent Application Publication
(10) Pub. No.: US 2011/0209999 A1
(43) Pub. Date: Sep. 1, 2011

(54) Capillary driven lateral flow devices

(75) Inventors: Scott S. Sibbett, Corrales, NM (US); Gabriel P. Lopez, Durham, NC (US)

(73) Assignee: STC.UNM

(21) Appl. No.: 12/930,543

(22) Filed: Jan. 10, 2011

Related U.S. Application Data
(63) Continuation of application No. PCT/US2009/004065, filed on Jul. 14, 2009.
(60) Provisional application No. 61/134,998, filed on Jul. 16, 2008.
(60) Provisional application No. 61/135,057, filed on Jul. 16, 2008.

(51) Int. Cl. G01N 27/447; G01N 27/453; B01D 15/08

(52) U.S. Cl. 204/451; 204/641; 210/198.2

(57) ABSTRACT

A lateral flow device includes a porous medium layer having a two-dimensional shape in plan view that is capable of supporting near-constant velocity capillary-driven fluid flow and can be combined with electrodes in a manner to achieve to achieve electrokinetic molecule separation.

This application claims priority and benefits of U.S. provisional application Ser. No. 61/134,998 filed Jul. 16, 2008, and Ser. No. 61/135,057 filed Jul. 16, 2009, the disclosures of which are incorporated herein by reference.

### FEDERALLY SPONSORED RESEARCH

This invention was made with Government support under Grant Nos. CTS-0332315 and DMR-0611616 awarded by the National Science Foundation. The U.S. Government has certain rights in this invention.

### BACKGROUND OF THE INVENTION

1. Field of the Invention

This invention relates to lateral flow devices comprising a two dimensionally shaped porous medium layer capable of supporting near-constant velocity capillary-driven fluid flow and lateral flow devices that are combinable with electrodes in a manner to achieve electrokinetic molecule separation. The devices are useful in diffusional, multiphase contacting, and separation operations. More specifically, the devices are useful in various chemical and biochemical assays, including lateral flow test strips.

2. Description of the Prior Art

Membrane-based lateral flow immunoassay tests provide quick and low-cost detection of various important physiological analytes. Common urine-based tests include those for glucose, human chorionic gonadotropin (pregnancy hormone) and 9-tetrahydro-cannabinol (pharmacological agent of marijuana); blood-based kits include those for cholesterol, diabetes, hepatitis C, and human immunodeficiency virus type 1. These tests are used widely in health care and home settings.

All commercially-available lateral flow test strips today are rectangular in shape, and comprised of at least one or more layers of porous material (FIG. 1). When wetted with an analyte-containing liquid (usually aqueous), the porous material provides a motive force for the movement of bulk liquid from wet to dry areas of the strip. The main motive force is capillary action. This flow of bulk fluid enables a controlled movement of analyte across specific, well-defined segments of the test strip which have been previously modified to contain various color-forming reagents. In general, a typical state-of-the-art lateral flow test strip expresses a line of a certain color only in the presence of the analyte. For example, a state-of-the-art lateral flow test kit is sold by Quidel Corporation under the brand name QuickVue. The QuickVue test allows for the rapid, quantitative detection of influenza type A and type B antigens directly from a nasal swab specimen. The test involves the extraction of the antigens by the following procedure. First, the nasal swab specimen is obtained by inserting a sterile swab inside the patient's nose, and gently rotating. The swab is then inserted into a test tube containing approximately 5 mL of solution which disrupts viral particles in the specimen, thereby exposing internal viral nucleoproteins. The swab is removed from the test tube. A lateral flow test strip is then inserted into the test tube, contacting the solution in the test tube and causing the analyte nucleoproteins to be swept with the bulk fluid, by capillary action, from the wetted region of the strip to the dry region. As the nucleoproteins are swept along, they pass regions of the strip which are precoated with certain specific chemicals. For example, in a double antibody sandwich reaction scheme, free antigen (viral nuceloprotein) encounters a labelling region which is pre-coated with an antibody/colored-microsphere complex. Due to a high affinity constant, effectively all antigen binds with a complex molecule, and the resulting antigen-antibody/colored-microsphere complex is then carried by capillary action to another region, which is pre-coated with a second antibody that is specific for a second antigenic site on the viral nucleoprotein. The second antibody is covalently bound to the site, hence any passing antigen-antibody/colored-micro sphere complex is captured in the region. In the absence of free antigen in the original patient specimen, the antibody/colored-microsphere complex is not bound at the second region, but, for control purposes, is captured at a third region pre-coated with antibody for antibody/colored-microsphere complex. This third region also captures any excess antibody/colored-microsphere complex molecules. Hence, at the conclusion of a positive test, color forms at both the second and third “test indicator” regions; whereas at the conclusion of a negative test, color forms only at the third region. Other reaction schemes exist; e.g., the competitive reaction scheme, the “Boulders-in-a-stream” reaction scheme, etc. But the standard format of these and all other lateral flow tests is a rectangular lateral flow test strip. In some cases, the rectangular strip is encased in a plastic cassette to enhance the reproducibility of fluidic control, minimize operator error, mechanically clamp various components of the strip, etc. But in all cases the basic format and operation of the state-of-the-art lateral flow test strip is a rectangle of porous media, wetted at one end to drive bulk fluid by capillary action through regions precoated with certain chemicals, which in turn, directly or indirectly signal the presence or absence of a given analyte.

Electrochromatography and electric field gradient focusing are known techniques for separation of molecules. For example, electrochromatography is described in Hoppe-Seyler's Z. Physiol. Chem. 338:211, 1964. Electric field gradient focusing to separate proteins is described by Dimiter N. Petsev et al. in “Microchannel protein separation by electric field gradient focusing”, Lab Chips, 2005, 5, pp. 587-597.

### SUMMARY OF THE INVENTION

The present invention involves in one embodiment a lateral flow device comprising a two dimensionally shaped porous medium layer capable of providing near-constant velocity capillary-driven fluid flow.

In illustrative embodiment of the invention, the lateral flow device comprises a porous medium layer having a first wettable region connected to a second region having a two dimensional shape selected to provide an increasing pore volume in a manner to establish a near-constant capillary driven fluid flow in the first region. The second region has an expanded or larger area in plan view for a given thickness and porosity of the porous medium layer to this end. In a particular illustrative embodiment, the lateral flow device comprises two-dimensionally shaped elements or regions that comprise a porous medium, such as nitrocellulose, with or without a backing substrate that is impervious to fluid flow, for example, and that include (1) a rectangular or near-rectangular stem element or region communicated with (2) a larger surface area element or region such as a circle, circular sector of any central angle less than 360 degrees and greater than approximately 90 degrees, a square, rectangle or other suitable shaped element or region. The first and second elements or regions can be joined separate pieces or preferably are formed as a unitary piece, such as a one-piece, two dimensionally shaped layer of given thickness and porosity throughout.

Near-constant velocity flow is obtained by wetting the first (e.g. rectangular) element or region and allowing the fluid to be driven by capillary flow from the wetted first region to the dry second region. Eventually the fluid front passes from the rectangular element or region to the large surface area second element or region. It is at the point in time that near-constant velocity flow is obtained in the rectangular element or region only.

The present invention involves in another embodiment a lateral flow device comprising a two dimensionally shaped porous medium layer combined with electrodes in a manner to achieve electrophoretic molecule separation by electrochromatography, electric field gradient focusing, etc.

In an illustrative embodiment of the invention, an electrochromatographic lateral flow device comprises a two-dimensionally shaped porous medium layer having a first region of the type described above with positive and negative electrodes operatively associated therewith and a higher pore-volume second region of the type described above connected to the first region and to which separated molecules move by electrophroesis and where the separated molecules optionally can be identified.

In another illustrative embodiment of the invention, an electric field gradient focusing lateral flow device comprises a two-dimensionally shaped porous medium layer having a first region with one or more electrodes operatively associated therewith and an enlarged higher pore-volume second region connected to the first region to which separated molecules move by capillary flow and where the separated molecules optionally can be identified.

Further details and advantages of the present invention will become more readily apparent from the following detailed description taken with the following drawings.

### DESCRIPTION OF THE DRAWINGS

FIG. 1 is a conceptual schematic of fluid flow.

FIG. 2 shows time-dependent capillary-driven displacement of liquid fronts of a two-dimensionally shaped nitrocellulose membrane.

FIG. 3 shows simulated time-dependent capillary-driven displacement of liquid fronts of a two-dimensionally shaped nitrocellulose membrane.

FIG. 4 is a finite element simulation of fluid streamlines (arrows) and velocity of shape A at time=10 seconds.

FIG. 5 is a finite element simulation of fluid streamlines (arrows) and velocity of shape B at time=300 seconds.

FIG. 6 shows the finite element simulation of substantially steady-state velocity determined at positions P5, P6, P7, and P8 of the two-dimensional lateral flow device shown.

FIG. 7 shows capillary flow into a shape of complex two-dimensional shape for times of 1, 11.5, 12.8, 14.1, 17.6, and 26.6 seconds with different hatching and arrows showing advance of the fluid front.

FIG. 8 illustrates parameters of a sector of an annulus.

FIG. 9 shows the frontal displacement versus time for inhibition in a capped rectangular porous nitrocellulose membrane capped with vinyl cover tape. Experimental, analytical, and simulation results are plotted for imbibition in a rectangle of nitrocellulose capped with vinyl cover tape. Data is plotted against both distance and distance squared; arrows indicate the applicable axis. Membrane dimensions were 1.0 cm by 9.0 cm. Nitrocellulose membranes were initially dipped to a depth of 0.3 cm in a Petri dish of water. Time of displacement of the advancing fluid front was recorded at 0.5 cm intervals pre-marked on the center axis of each membrane. The upper curve is comprised of two very closely overlapping lines, one solid line representing results obtained from the Lucas-Washburn equation, and a second dashed line obtained from the simulation. Experimental data points on the lower curve are plotted as obtained for 3 replicates per experimental run. Apparent contact angle, θₐ=82.2°; surface tension of water γ=72.8 mN/m; mean pore size rₘ=4.5 μm; viscosity of water=8.9×10⁻⁴ Pa sec at 25° C.; and density of water 998.2 kg/m³.

FIG. 10 shows locations of band centers in a 270° fan membrane as a function of elapsed time. The plot summarizes quantitative velocity data obtained from time-lapse photos. Each curve represents the flow of one dye band in a 270° fan. Line slope is a graphical indicator of band velocity. The curvature of all bands shown indicates that they decelerate as they pass into the circular sector of the fan (a truncated half of which is depicted in proper scale as a line figure adjacent the y-axis). Fluid in the lower about 3 cm of the fan maintains approximately the same velocity over the entire approximate 22 minutes of the experiment as indicated by the near-constant slopes of all 22 lines in the initial 3 cm of movement. To aid the eye in assessing the slopes of lines in the first 3 cm, dashed lines are added; these merely extrapolate the first 2 data points of each band. Also plotted on the fan are the location of points P6 and P7 (half circles adjacent to y-axis).

FIG. 11 shows velocity of inhibition as a function of time for 270° fan-shaped membrane. Solid curves are predicted results: curve a, velocity at point P6 of the 270° fan; curve b, velocity at point P7 of the 270° fan; curve c, velocity at a point on a rectangular membrane just above the surface of the reservoir in which the rectangular membrane was dipped, as predicted both analytically and by simulation. Points P6 and P7 are both on the centerline of the fan. Point P6 is 2 cm above the surface of the reservoir; and therefore about at centerpoint the rectangular stem of the fan. Point P7 is about 3.4 cm above the surface of the reservoir, and therefore in the region where the sem joins the circular sector. For modeling purposes, θₐ=70° while the sink term, F, to simulate 50% relative humidity of the experiments was −1.70 kg/m³ second. Experimental data points shown are computed from the data of FIG. 10. Solid squares are measured velocity at point P6 and asterisks are measured velocity at point P7.

FIG. 12 is a schematic view of an electrochromatographic lateral flow device pursuant to another illustrative embodiment of the invention.

FIGS. 13 and 14 are schematic views of electric field gradient focusing lateral flow devices pursuant to other illustrative embodiments of the invention.

FIGS. 15A and 15B illustrate mesh deformation for ALE the method of modelling.

### DETAILED DESCRIPTION OF THE INVENTION

An embodiment of the present invention provides lateral flow devices comprising a two dimensionally shaped porous medium layer capable of supporting near-constant velocity capillary-driven fluid flow. The lateral flow devices can be shaped in two dimensions in plan view by cutting of a porous medium layer having a given substantially constant thickess and porosity throughout and optional fluid-impermeable cover layers. The porous medium layer and optional cover layers can be through-cut by knife edge, laser beam cutting or kiss cut by knife edge. The cutting preferably is computer controlled (e.g. X-Y computer control) to provide the two dimensional shapes.

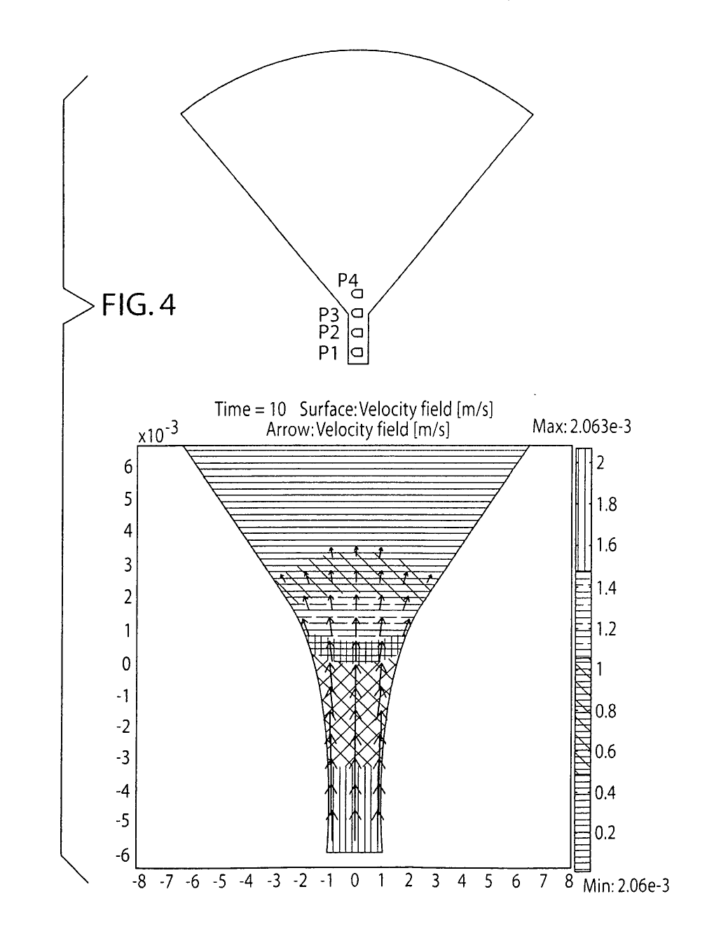

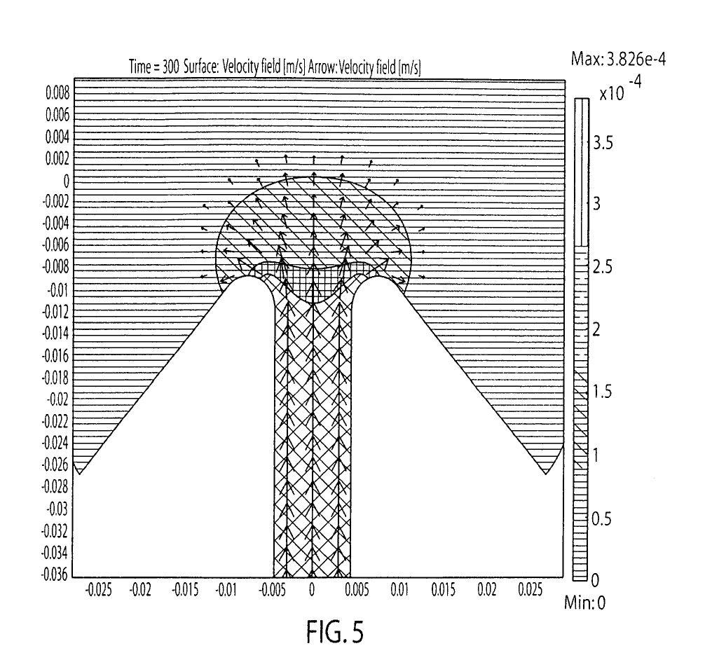

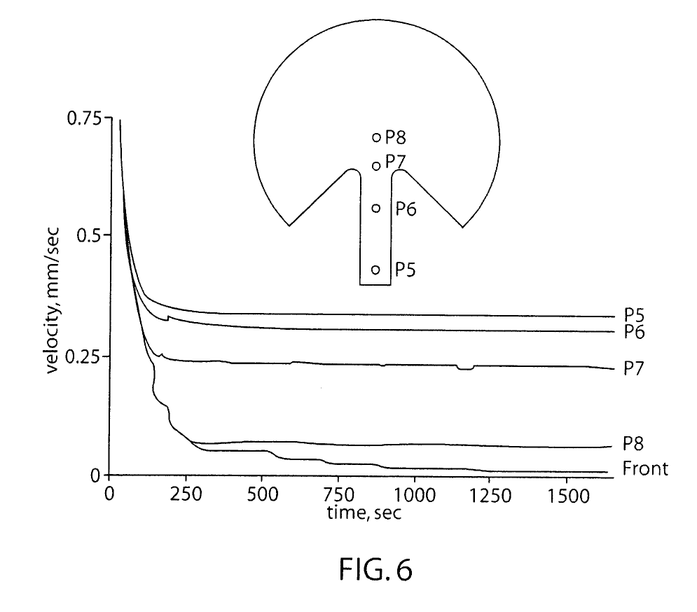

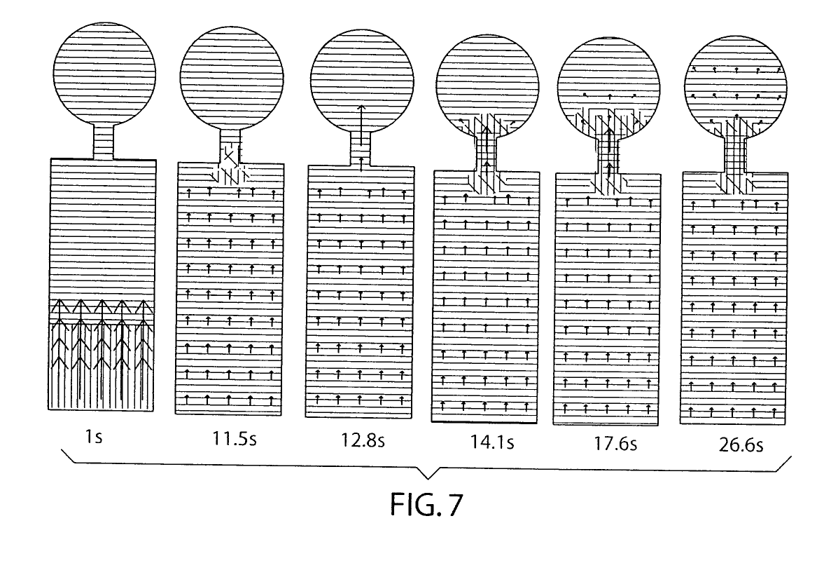

In illustrative embodiment of the invention, the lateral flow device comprises two-dimensionally shaped elements or regions that comprise the porous medium layer, such as nitrocellulose paper for example, and that include (1) a rectangular or near-rectangular stem element or region R1 in plan view of substantially fixed or constant cross-section joined to or formed as one piece with (2) a larger surface area element or region R2 in plan view such as a circle, circular sector of a central angle greater than approximately 90 degrees, a square, rectangle or other suitable shaped element having an expanded cross-section. For purposes of illustration and not limitation, the large surface area element or region R2 can be a circular sector of central angle of about 90 degrees connected to the rectangular element or region R1 (see FIG. 4); the large surface area element or region R2 can be a circular sector of central angle of about 270 degrees connected to the rectangular element or region R1 (see FIG. 5); or the large surface area element or region R2 can be a circle connected to a rectangular element or region R1 (see FIG. 6). In a preferred embodiment of the invention, the large surface area element or region R2 is a circular sector of central angle of about 270 degrees connected to the rectangular or near-rectangular element or region R1. The circular sector-shaped second region R2 in these embodiments provides a higher pore volume bed in cross section than the region R1 by virtue of the change in the two dimensional shape of the porous medium layer there for a given substantially constant thickness and porosity of the porous medium layer. The expanding or enlarged two dimensional circular sector shape in plan view of the second region R2 is selected to provide a continuously increasing pore volume in cross-section relative to the advancing fluid front. For purposes of illustration and not limitation, in these embodiments, the fluid (liquid) initially contacts the first region R1 and imbibes upwardly. Upon reaching the junction with the second circular sector-shaped region R2, the advancing fluid front then spreads radially so that a continuously increasing cross-sectional pore volume is provided ahead of the fluid front in the second region R2 as it advances in the second region. Although the first and second elements or regions can be joined separate pieces, preferably they are formed as a unitary piece such as a one-piece, two dimensionally, shaped porous layer. The terms “region or regions” will include separate joined and/or one-piece elements or regions of the porous medium layer for sake of convenience.

Near-constant velocity flow is obtained by wetting the rectangular region R1 and allowing the fluid to be driven by capillary flow from wet region S1 to dry region R2. Eventually the fluid front passes from rectangular region R1 to the large surface area region R2, which has a higher pore-volume for a given thickness and porosity of porous medium layer due to the change in two dimensional shape there. At this point in time and travel of the fluid front, a near-constant velocity flow is established in the rectangular region R1 only. The near-constant velocity flow appears to result from conservation of mass, governed by the continuity equation, of a fluid stream which expands from a region of fixed cross-section to a region of expanding or larger cross-section, although applicants do not wish or intend to be bound by any theory for the near-constant velocity fluid flow effect.

The porous medium layer can comprise nitrocellulose sheet, chromotography paper, or other porous material that exhibits fluid capillarity and has a substantially constant thickness and porosity throughout. The porous medium layer can be backed by an optional protective fluid-impermeable layer and also can be sandwiched between optional protective fluid-impermeable layers to provide a laminar composite lateral flow device. This minimizes evaporation and protects the devices from contamination and dehydration. The protective films also circumvent the need for the conventional hard plastic cassette holders that are typically used to package commercial lateral flow diagnostic strips, thereby reducing cost per device and simplifying manipulations by users in the field. The lateral flow devices pursuant to the present invention do not require pumps, syringes, filters, electric power supplies or other ancillary devices since they employ capillary action to drive analyte-containing fluids to specific bioreagent, immunological reagent, or chemical reagent spots or lines on a given testing region of the two dimensional shape.

The following Examples are offered to illustrate but not limit the present invention.

### Example 1

### Two Dimensional Shape Cutting Procedure:

Two mil clear polyester-backed sheets of Hi-Flow Plus 135 porous nitrocellulose membranes (no. HF13502XSS) were cut to the shapes described below and shown in the drawings using a computer-controlled X-Y plotter that incorporated a knife in place of the traditional ink pen. The nitrocellulose membrane (layer) has a substantially constant thickness and porosity throughout. The X-Y plotter was a Graphtec FC700075 plotter from Western Graphtec Inc., Irvine, Calif. and provided motion of the sheet in the y direction by rollers of the plotter and in the x direction by knife carriage motion. The knife was provided by the manufacturer of the cutting plotter and rotated freely on a turret where the traditional ink pin would reside, enabling precise cutting of various features, including small-radius corners or holes. By appropriate adjustment of knife blade angle and downward force, nitrocellulose sheet was readily cut with a single pass. Following cutting operations, the removal of unwanted material (‘weeding’) was performed manually. The knife plotter can be programmed to cut multiple devices from single sheets up to about 1 m in width, and of unlimited length.

### Experimental Methods

The membrane used in all experimental runs was Millipore Hi-Flow HF135 nitrocellulose (Millipore Corp., Billerica, Mass.). Membranes were cut to two-dimensional shapes by a computer-controlled cutting machine, as described above in Two Dimensional Shape Cutting Procedure. At the outset of an experiment, the edge of a given membrane was briskly dipped into a liquid-filled Petri dish to a uniform depth of 3 mm, and clamped in a fixed position. Unless specified otherwise, all experimental runs were conducted in a humidity-controlled glovebox of relative humidity 50%±2%. By human eye, measurements were recorded of the duration of travel of liquid fronts to pre-designated distance markers. With this protocol, the estimated operator error in gauging the time of arrival of a given liquid front at a distance marker. Estimates of this error are shown as error bars in all figures presented here; where no error bars are shown, the error is within the width of a given data marker. The leading and trailing ends of a given error bar correspond to estimates of the earliest and latest possible times of arrival of a given front.

Flow velocities of the fluid trailing a front were measured by launching a series of alternating dye and pure water bands, and measuring the time of travel of bands across pre-measured distance markers. Dyes used in these experiments were obtained from commercially-available food coloring, and were determined to be unaffected by chromatographic sieving within the nitrocellulose.

### Computational Methods

### Model of Capillary Action in Porous Media:

Washburn's equation describes the velocity of capillary flow in a capillary tube of uniform internal circular cross-section:

$$\frac{d z}{d t} = \frac{a γcos θ}{4 μ z} \qquad ( 1 )$$

where z is length of the capillary, a is capillary radius, γ is surface tension of the liquid, θ is contact angle, and μ is viscosity. This equation states that the velocity of capillary flow is proportional to the radius of the capillary, the cosine of the contact angle, the ratio of the surface tension to the viscosity of the liquid, and inversely proportional to the length of substrate already wetted by the liquid. The system to which this equation applies is, however, substantially different from porous media, such as a nitrocellulose membrane, comprised of a continuous network of pores of non-uniform shape and size. The flow dynamics of porous media is described by Darcy's Law:

$$Q = \frac{k A Δ P}{μ L} \qquad ( 2 )$$

where Q is volumetric flow rate, k is permeability of the material, A is the normal cross-sectional area of the porous material, ΔP is the pressure difference across the length of the material, μ is viscosity of the liquid, and L is length of material in the direction of fluid. The results presented here employ a pseudo three-dimensional capillaric permeability model which assumes a bundle of three sets of capillary tubes, all of uniform average cross-sectional area in which a third of the capillaries are aligned with the x coordinate axis, a third with y, and a third with z. Hence, permeability is computed by the following expression:

k=φa²/24 (3)

where φ is porosity. The magnitude of capillary pressure ΔP is obtained from Laplace's equation:

$$Δ P = \frac{2 γcos θ}{{r}_{m}} \qquad ( 4 )$$

where rₘ is the average pore size. See Dullien F A L, Porous Media: Fluid Transport and Pore Structure, 2^{nd} ed. New York, Academics Press 1992.

### Numerical Analysis:

Equation 2 was solved using COMSOL 3.3 (COMSOL AB, Stockholm). Input parameters used in the analysis were as follows: viscosity of water, 8.9×10⁻⁴ Pas; surface tension of water, 0.0728 N/m; density of water, 998.2 kg/m³; porosity of nitrocellulose, 82-83%; average pore size of nitrocellulose, 8-10 μm; and contact angle of water on nitrocellulose, 60 deg. The input values of porosity and average pore size are those furnished by the supplier. The contact angle is an estimate based on: (i) a known value of the static advancing contact angle of water on non-porous nitrocellulose (viz., ˜70 deg); and (ii) the expected effect of pore network tortuosity on the contact angle of porous nitrocellulose, which we estimate to be a 10 deg decrease. Details of the arbitrary Lagrangian-Eulerian (ALE) method are provided below.

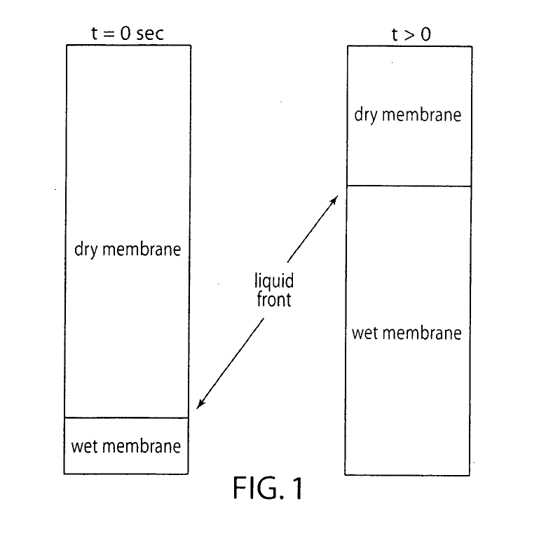

FIG. 1 depicts a rectangular nitrocellulose membrane at t=0 sec, consisting of wet and dry domains. At tₒ, the wet domain is the region of the membrane that has been dipped into a water reservoir of infinite capacity, and into which water has penetrated and filled all pores. At t>0, the interface between dry and wet domains moves from wet to dry according to Darcy's Law (FIG. 1). An insulation and symmetry boundary condition is applied to all peripheral edges of the membrane except the locus of capillary pressure, the bottom edge.

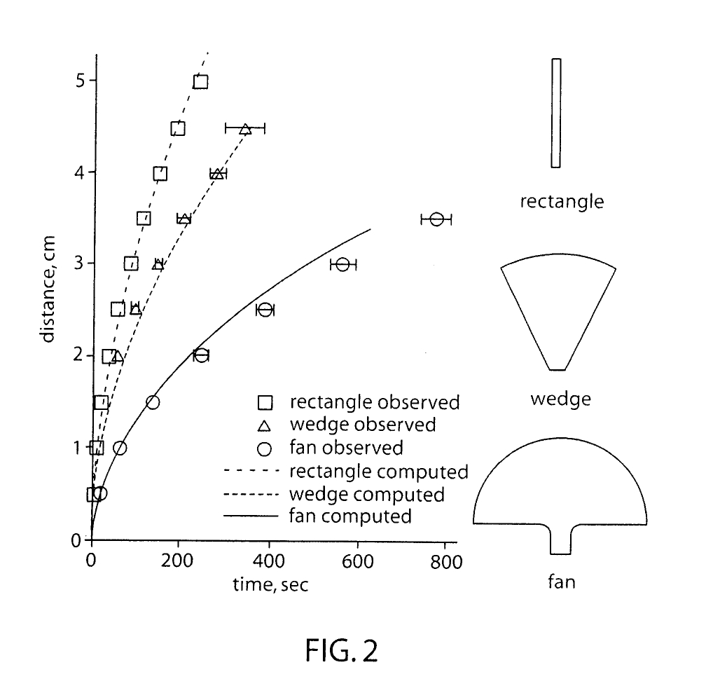

FIG. 2 shows computed and experimental results of the movement of liquid fronts in rectangle-shaped, wedge-shaped and fan-shaped nitrocellulose membranes. FIG. 2 employed membrane dimensions as follows: rectangle, 6×1 cm; wedge, 5 cm at center axis, 0.5 cm base, 45 deg angle; fan, rectangle segment 1.0 width×1.3 cm height, circular sector diameter 7.5 cm and central angle 180 deg. Experimental data was obtained at 50% RH±2% (RH=relative humidity). Membranes were initially dipped to a depth of 0.3 cm into a Petri dish of water. Time of displacement was recorded at 0.5 cm intervals pre-marked along the center axis of a given membrane. The distance of the first of these distance markers from the bottom edge of a given membrane was as follows: rectangle, 0.8 cm; wedge, 0.8 cm; fan, 1.3 cm.

It is observed that the computed results tend to match the experimental results, and that the closeness of fit decreases slightly from rectangle to wedge to fan. This trend is a consequence of the conservation of mass as described by the continuity equation. A similar explanation holds for the observation that flow velocity at any given value of t decreases significantly from rectangle to wedge to fan. For an incompressible fluid, flux into a diverging volume is accompanied by a reduction in velocity. The trend in diverging volume is rectangle<wedge<fan, and, accordingly, the observed trend in flow velocity is rectangle>wedge>fan.

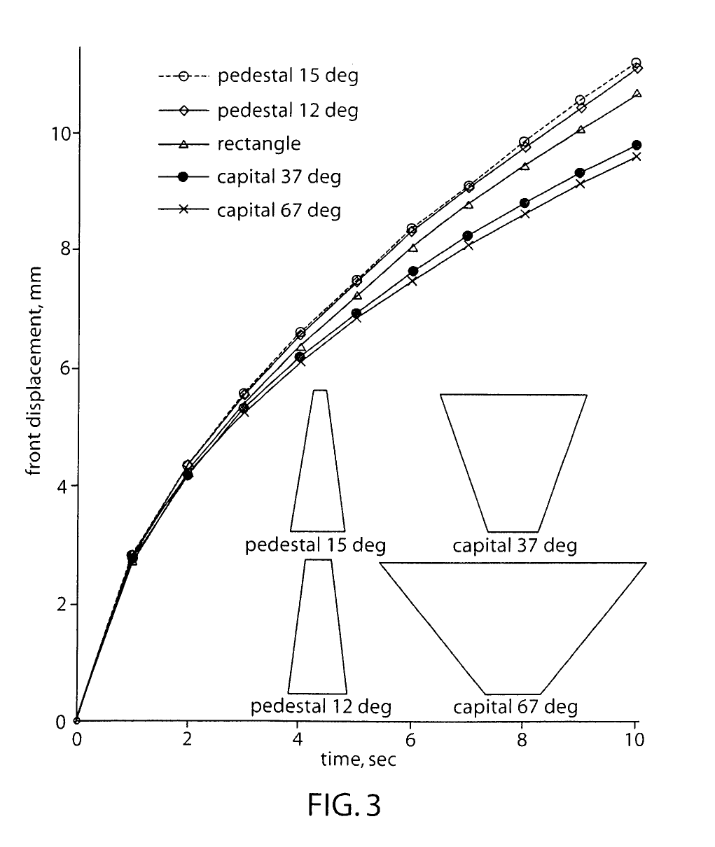

FIG. 3 shows the computed and experimentally observed displacement of liquid fronts for the following 5 shapes: (i) a pedestal of angle 15 deg; (ii) a pedestal of angle 12 deg; (iii) a rectangle; (iv) a capital of angle 37 deg; and (v) a capital of angle 67 deg. In all cases, the direction of travel of liquid is from bottom to top in the orientation depicted. For any given time t, the trend in velocity is pedestal>rectangle>capital. Within shape types, there are small differences in velocity as a function of angle.

Two novel shapes were investigated for their ability to support near-constant-velocity capillary-driven flow. Both shapes consist of a rectangle joined to a circular sector. The two shapes differ only by a different central angle: for Shape A, the central angle is 90 deg; for Shape B, 270 deg. The basic concept of Shapes A and B is as follows: (i) by contacting liquid on one end of the rectangle, capillary-driven flow occurs from the wetted end of the rectangle to the dry circular sector; during this first phase, flow in the rectangle is governed by Darcy's Law; (ii) when the liquid front reaches the dry circular sector, it encounters a sudden increase in the available bed volume of dry porous media; and (iii) with further penetration of the liquid front into the circular sector, the liquid front encounters a continuously increasing available bed volume; during this second phase, flow in the rectangle is governed primarily by the continuity equation, and therefore flow within the rectangle attains a constant velocity with time, and is no longer governed by Darcy's Law.

### Supplementary Information:

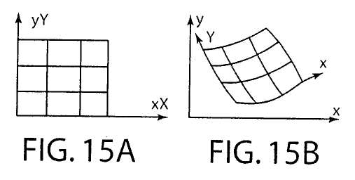

The arbitrary Lagrangian-Eulerian (ALE) method was used to model the time-dependent boundaries of the multi-physics domains. ALE is based on the recognition that, for certain problems, the initial coordinates of a mesh node transform over computational time to a deformed configuration (FIGS. 15A and 15B). The deformation is caused by the computed results. For example, in the case of capillary flow in porous media, the mesh deforms in wet and dry regions due to the computed movement of the liquid front through the media. To correct these effects, the ALE method: (i) monitors deformation in realtime; (ii) halts the numerical analysis when the deformation reaches a certain operator-specified level; (iii) generates a new and improved mesh; (iv) restarts the analysis; and (v) iterates steps i-iv as many times as necessary to finish the analysis. By this process, large displacements of a liquid front in porous media can be accurately computed.

### Example 2

The following examples both mathematically and experimentally how a continuous increase in unwetted pore volume causes a deviation from traditional inhibition, and leads to quasi-stationary velocity flow in the rectangular element. These results are both theoretically and practically important because they indicate how medical diagnostic test strips may be fabricated without incorporating an absorbent pad.

The flow of sample to reagent is driven by capillary action within pores of the film. First, the membrane is contacted with an aqueous sample and held in place, thereby filling all submerged pores and creating a wetted region. For times t>0, the liquid-air interface within the membrane migrates towards dry regions as a consequence of a surface-tension induced pressure differential at the interface. There is a qualitative analogy between such flows through porous media, and the capillary action of an array of dry, hydrophilic capillaries dipped in fluid: for each capillary in the array, curvature at the air-liquid interface creates a force that drives migration of the interface towards dry regions. In a porous membrane of constant cross-section, liquid moves according to Darcy's Law

$$〈 {u}_{S} 〉 = \frac{{k}_{S} Δ P}{μ {L}_{c}} \qquad ( 1 )$$

where <uₛ> is the superficial fluid velocity, kₛ is the superficial permeability of the porous medium, ΔP is the pressure difference over the length L_{c} of the liquid-filled region, and μ is the viscosity. Liquid flows towards dry regions, whether the interface is one among many in an array of geometrically well-ordered capillaries, or in a torturous network of interconnected pores.

The driving force for the imbibition is the capillary suction pressure P_{c} given by the equation

$${P}_{c} = \frac{2 γcos θ}{{r}_{m}} \qquad ( 2 )$$

where γ=surface tension, θ=contact angle of the liquid with the material, and rₘ=mean pore radius. For the simplest one-dimensional model of a porous rectangular strip, it is well known that the wetted area covers a distance l(t)

$$l ( t ) = 2 \sqrt{\frac{{k}_{S} γcos θ}{φμ {r}_{m}}} \sqrt{t} \qquad ( 3 )$$

when l(0)=0, and where φ is porosity of the material. This result is known as the Lucas-Washburn equation. It predicts that flow velocity diminishes with increasing time. In the presence of the absorbent pad, flow is sustained over time because liquid in the thin membrane: (i) contacts the porous pad; (ii) imbibes into a porous space of widening cross-section; and (iii) encounters a continuous increase in unwetted pore volume as it advances. Hence, the constant cross-section assumed by Lucas-Washburn dynamics does not apply, causing flow to deviate from eq 3.

In these Examples, we show experimentally, analytically and numerically how a continuous increase in pore volume causes a clear deviation from Lucas-Washburn dynamics, namely quasi-stationary (near-constant) velocity flow.

### Experimental Section

The membranes used were Millipore Hi-Flow HF135 nitrocellulose (Millipore Corp., Billerica, Mass.). This membrane is comprised of a thin film of porous nitrocellulose on a substrate of polyester. Membranes were cut into two-dimensional shapes by a computer-controlled cutting machine. In some experiments, the nitrocellulose side of HF135 was capped with vinyl cover tape (from G&L Precision Die Cutting, Inc., San Jose, Calif.) to form a laminar composite. No evaporation of fluid occurs within these capped devices except along the peripheral edge where a thin layer of nitrocellulose is exposed. Capped devices are of interest because: (i) they remain clean; (ii) they remain dry; (iii) evaporation is negligible; (iv) experimental results are easily obtained; (v) models do not require an evaporation term; and (vi) capped devices are probably better suited than non-capped devices for use in resource-poor areas. The reported thickness of HF-135 nitrocellulose is 135±15 μm, hence the absolute amount of liquid lost to the ambient by evaporation from capped devices is small: we have measured it to be <3% of the total liquid in a typical device over the course of a typical experiment. Experiments with uncapped membranes were conducted in humidity-controlled chambers; capped membranes were tested under conditions of ambient humidity.

Dyes used were Allura Red AC and Acid Blue 9 (Great Value Assorted Food Colors and Egg, Dye, Wal-Mart Stores, Inc., Bentonville, Ariz.). They were selected based on observations that these particular dyes are not subject to chromatographic sieving by nitrocellulose.

At the outset of an experiment, the edge of a given membrane was dipped in a Petri dish filled with liquid to a uniform depth, then held in a fixed position. Measurements were taken of the duration of travel of liquid fronts to distance markers scribed on the membrane. With this protocol, there exists operator error in gauging the time of arrival of a given liquid front at a distance marker. Estimates of this error are shown as error bars in all figures presented here; where no error bars are shown, the error is within the width of a given data marker. The leading and trailing ends of a given error bar correspond to estimates of the earliest and latest times of arrival of a given front.

In all cases, the observed profile of an advancing fluid front is even and uniform, even to the cut edge of the membrane. In the case of water imbibition in a 20×2 cm strip of uncapped nitrocellulose, the profile of the front remained flat over a period of 25 minutes, with occasional deviations that impart a slight waviness to the profile. These deviations disappear within a few seconds of appearing. We interpret this behavior to indicate that when any one region of a front happens to move ahead of another, the more advanced portion encounters unwetted nitrocellulose longitudinally, which induces some portion of the advanced fluid to move longitudinally into the unwetted region. In turn, this longitudinal flow slows down the advanced portion of the front, and speeds up the retarded portion. The net effect is to maintain an even and uniform profile of the wetted area.

Flow velocity measurements were obtained from time-lapse photographs of a sequence of launched dye bands.

For all experiments, one end of the membrane was dipped vertically into a reservoir of water, hence imbibition occurred in the direction opposite gravity. For both analytical and numerical analyses, we neglected gravity because experimentally we observe no significant difference between membranes positioned vertically versus horizontally (data not shown).

COMSOL Multiphysics 3.4 finite-element software (COMSOL Inc., Burlington, Mass.) was used to solve a set of simultaneous partial differential equations, namely Darcy's law

$$v = - \frac{{k}_{i}}{μ} ∇ P \qquad ( 4 )$$

and the mass balance equation

$$∇ \cdot [ ρ ( - \frac{{k}_{i}}{μ} ∇ P ) ] = F \qquad ( 5 )$$

where ρ is the fluid density, kᵢ is the interstitial permeability

$${k}_{i} = \frac{{k}_{s}}{φ} \qquad ( 6 )$$

and F is a sink or source term. In the case of capped devices, F was set to zero. In the case of uncapped devices operated in a humidity-controlled ambient, F was computed by Knudsen's equation to be −1.70 kg/m²·sec at a relative humidity of 50%.

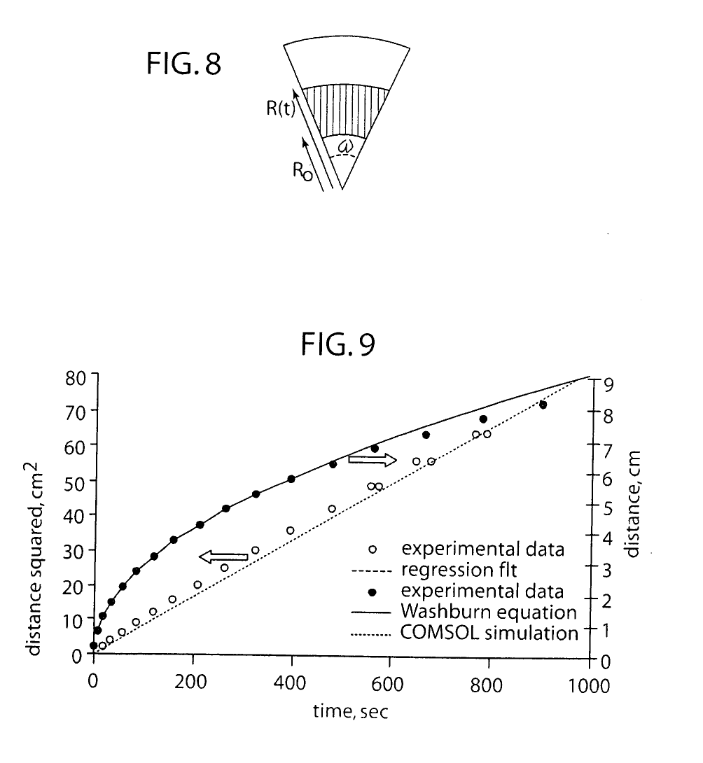

A fan is defined here to be a rectangle appended to a circular sector (the portion of a circle enclosed by two radii and an arc). The central angle, ω, of the appended circular sector of a fan may vary from 0°<ω<360° (FIG. 8). A fan with ω of 180° is shown in FIG. 2. In a porous membrane or layer in the shape of a sector of a circle (annulus), liquid from the first region R1 first contacts the layer along the curve at the bottom of the layer and then imbibes upwardly and spreading radially where R₀ is the inner radius of the circular sector as shown in FIG. 8. The extent of radial imbibition at time t is represented as R(t).

Imbibition within a fan proceeds in two phases:

Phase 1: Upon contacting liquid at the base of the rectangle, capillary-driven flow occurs from the wetted end of the rectangle towards the dry circular segment (referred to hereinafter as the circular segment.) During this first phase, flow in the rectangle is governed by the Lucas-Washburn equation (eq 3).

Phase 2: When the liquid front reaches the dry circular sector, it encounters a sudden increase in the available bed volume of dry porous media. As the front advances radially, there is continuous increase in the available pore bed volume. By analogy with the absorbent pad of a typical lateral flow assay, we can predict in Phase 2 that the velocity of flow within the rectangular segment will not obey Lucas-Washburn hydrodynamics, but rather be sustained over time, up to the limit of complete saturation of the circular segment. As an example of the dynamics, over the course of a 26 minute experiment in which water and food coloring were alternately imbibed into a 270° fan, we observe that the velocity of liquid in the rectangular stem of the fan is quasi-stationary. Specifically, time-lapse photography shows that, after the first 3 minutes, the number of bands within the stem remains constant at 3 bands, and each of these 3 bands is in essentially the same location from one photograph to the next. This result indicates that the velocity of flow in the rectangular stem is not changing appreciably.

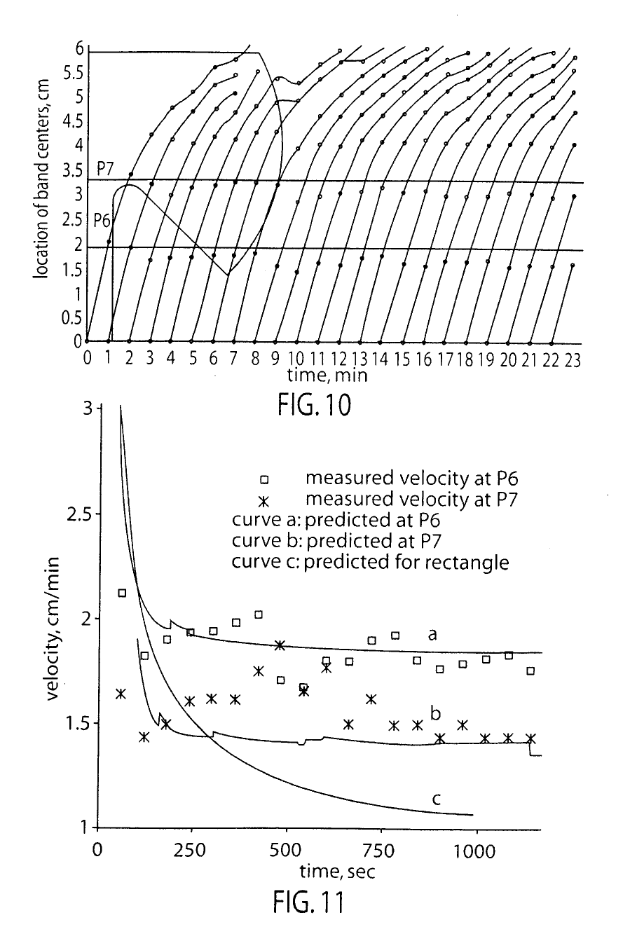

Moreover, a graph of the location of band centers as a function of elapsed time reveals that the slopes of curves of individual bands in the stem are nearly constant over the full 26 minutes of the experiment (FIG. 10). The slopes of these curves graphically reflect fluid velocity. From these slopes, we plot velocity versus time at two locations within the stem: P6, located midway in the rectangular segment, and P7, located where fluid just begins to spread out as it enters the circular segment (FIG. 11). Over a time period of 18 minutes, bulk fluid velocities at locations P6 and P7 are approximately constant at ˜1.8 and ˜1.6 cm/min, respectively. The difference in flow velocity at P6 versus P7 is due to the effect of radial flow in the circular segments. This effect reduces fluid velocity at any point within the circular sector relative to any point in the rectangular segment, as can be seen from a simulation of the streamlines and a color-coded velocity map.

FIG. 11 also contains simulation curves of the predicted velocity at locations P6 and P7. We see that velocity is predicted to be initially high (Phase 1, t<˜200 sec), drop rapidly, and stabilize at roughly fixed values (Phase 2, t>˜200 sec). A close match is observed between simulation and experimental results in Phase 2.

In Phase 1, the extent of the match is obscure. This is due to two limitations of the experimental protocol. First, the collection of time-averaged velocity data cannot begin until the fluid front has crossed the location of interest. This takes ˜50 sec in the case of P6, and ˜120 sec in the case of P7. Second, 4 separate bands are needed for computing one velocity data point. Since these bands are launched only once every 30 sec, then 120 sec is required per data point. Hence, velocity data reported here in the time period t<˜170 sec carries a significant degree of imprecision due to measurement delays and long time-step time-averaging. Not surprisingly, it does not corroborate the prediction of initially high velocities.

The prominent result of FIG. 11 is that curve c is significantly different from either curve a or b in Phase 2. In other words, flow in a simple rectangle (curve c) is dramatically different from flow in a rectangle that comprises the stem of a fan (curves a and b). From FIG. 11, we conclude that sustained flow has been achieved, that the conventional Lucas-Washburn dynamics of eq. 3 do not apply, and that a two-dimensional mimic of absorbent pads has been demonstrated.

It is of interest to understand theoretically whether such flow is steady or quasi-steady. It can be shown mathematically that once the liquid front enters the circular segment, the volumetric rate of flow is approximately constant over time at a value given by

$$q \approx \frac{{k}_{i} d {P}_{c}}{μ {L}_{r}} \qquad ( 7 )$$

where d is the width of the rectangular stem of the fan, Lᵣ is the length of the rectangular segment (FIG. 2), and capillary pressure P_{c} is given by eq 2. The length of time over which eqn 7 pertains depends on the device dimensions ω, Lᵣ and d. In the specific case of the device of FIG. 6, we observe quasi-stationary velocity flow for >22 min. For medical lateral flow assays, the detection of rare molecules requires imbibition of sufficiently large volumes of sample. Hence, fan-shaped devices provide an alternative to the incorporation of a conventional absorbent pad.

The proper functioning of a lateral flow biomedical assay requires sustained liquid flow across one or more reaction zones. This type of flow is a critical parameter in maximizing test sensitivity, and is especially important in the detection of rare biomolecules. The invention can provide sustained liquid flow with thin porous membranes formed in the shape of a fan. We have shown both mathematically and experimentally how a continuous increase in unwetted pore volume causes a deviation from Lucas-Washburn dynamics, and leads to quasi-steady flow. These results are both theoretically and practically important because they indicate how medical diagnostic test strips may be fabricated without incorporating an absorbent pad, the standard means of generating sustained liquid flow in lateral flow assays sold commercially today.

Pursuant to the invention, multiplex lateral flow test strips can be fabricated without the need for the adsorbent pad to reduce cost and fabrication complexity. The effect on flow of membrane non-rectangular shapes can be modeled both analytically and by finite-element simulations, a topic of importance to membrane manufacturers and the lateral flow assay industry.

Our particular interest is in lateral flow devices which are fabricated to meet the needs of users in resource-poor areas. Typically, these users want devices that are: (i) low-cost; (ii) small, light weight and easily handled; (iii) impervious to ambient contaminants and humidity; (iv) operate without electrical power; (v) operate without special fluids such as buffer or filtered water; (vi) are not prone to operator error; and (vii) generate results in a few minutes or less. The present invention provides lateral flow devices that can be fabricated to meet these needs.

The above embodiments of the invention may find use for generating quasi-stationary flow is potentially applicable to thin layer chromatography, particularly those recent embodiments which benefit from continuous flow.

### Devices for Molecule Separation:

Another embodiment of the present invention provides lateral flow devices comprising a two dimensionally shaped porous medium layer combined with electrodes in a manner to achieve electrophoretic molecule separation that includes, but is not limited to, electrochromatography, electric field gradient focusing and other electrically-based techniques. The lateral flow device can be shaped in two dimensions in plan view by cutting of a porous medium layer of the type described above and optional fluid-impermeable cover layers. The porous medium layer and optional cover layers can be cut by mechanically kiss-cut or through-cut by knife edge, mechanical die cutting, laser beam cutting, punching, perforating, perforating and tearing along perforations, or other severing techniques to sever through the porous medium layer and optional cover layers. The cutting preferably is computer controlled (e.g. X-Y computer control) to provide the two dimensional shapes, all as described above.

The porous medium layer ML can comprise nitrocellulose sheet, chromatography paper, or other porous material that exhibits fluid capillarity. The porous medium layer can be backed by an optional protective fluid-impermeable layer and also can be sandwiched between optional protective fluid-impermeable layers to provide a laminar composite lateral flow device. This minimizes evaporation and protects the devices from contamination and dehydration. The protective films also circumvent the need for the conventional hard plastic cassette holders that are typically used to package commercial lateral flow diagnostic strips, thereby reducing cost per device and simplifying manipulations by users in the field. The lateral flow devices pursuant to the present invention do not require pumps, syringes, or filters since they employ electrophoresis and/or capillary action to drive analyte-containing fluids to specific bioreagent, immunological reagent, or chemical reagent spots or lines on a given region of the two dimensional shape.

For purposes of illustration and not limitation, the porous medium layer ML can comprise two mil clear polyester-backed sheets of Hi-Flow Plus 135 porous nitrocellulose membranes (no. HF13502XSS) which can cut to the two dimensional shapes in plan view described below and shown in the drawings using a computer-controlled X-Y plotter that incorporated a knife in place of the traditional ink pen. The X-Y plotter was a Graphtec FC700075 plotter from Western Graphtec Inc., Irvine, Calif. and provided motion of the sheet in the y direction by rollers of the plotter and in the x direction by knife carriage motion. The knife was provided by the manufacturer of the cutting plotter and rotated freely on a turret where the traditional ink pin would reside, enabling precise cutting of various features, including small-radius corners or holes. By appropriate adjustment of knife blade angle and downward force, nitrocellulose sheet is readily cut with a single pass. Following cutting operations, the removal of unwanted material (‘weeding’) was performed manually. The knife plotter can be programmed to cut multiple devices from single sheets up to about 1 m in width, and of unlimited length.

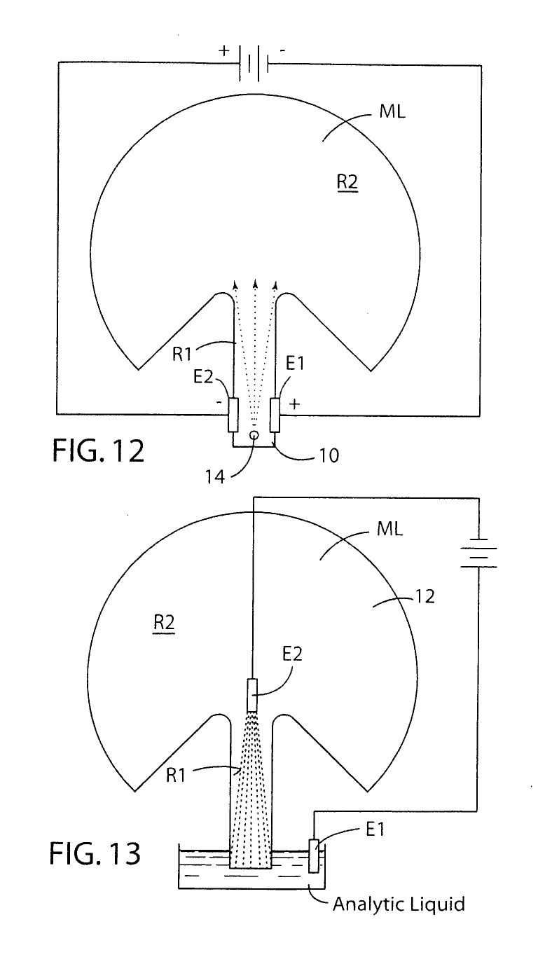

In illustrative embodiment of the invention shown in FIG. 12, an electrochromatography lateral flow device comprises a two-dimensionally shaped porous medium layer ML comprising, in plan view, a first region R1 of the type described above with positive and negative electrodes E1, E2 operatively associated therewith and an enlarged (in plan view) second region R2 of the type described above connected to the first region 10 to which separated molecules move by electrophroesis and where the separated molecules optionally can be identified. The first region 10 can have a rectangular shape in plan view, while the second region 12 can have a mushroom, circular sector shape in plan view for purposes of illustration and not limitation. The electrodes can be connected to a conventional power supply or battery as shown to provide a desired voltage between the electrodes.

The analyte liquid can be introduced into an inlet hole in an optional cover layer, if present, adhered on the porous medium layer ML or can be drawn by immersing the lower edge of the first region of the uncovered porous medium layer ML in analyte liquid residing in a container, such as a Petri dish.

The electrodes are placed in intimate physical and fluidic contact on opposite sides of the first region R1 of the porous medium layer ML so that analyte molecules having a net negative charge will move toward the positive electrode and analyte molecules having a net positive charge will move toward the negative electrode. The separated molecules move by continuous free-flow electrophroesis to enlarged second region 12 connected to the first region where the separated molecules optionally can be identified. For example, one or more reagent lines, spots or areas (not shown) can be placed at the second region R2 to react or interact with the molecules to this end to provide a detectable signal or color when analyzed by appropriate analysis techniques.

In illustrative embodiment of the invention shown in FIG. 13, an electric field gradient focusing lateral flow device comprises a two-dimensionally shaped porous medium layer ML comprising, in plan view, a first region R1 and an enlarged second region R2 connected to the first region R1 to which separated molecules move by electrophroesis and where the separated molecules optionally can be identified. The first region R1 can have a rectangular shape in plan view, while the second region R2 can have a mushroom shape or other shape such as a wedge, flute, and the like in which the cross-sectional area of the porous medium layer continuously varies (increases) for purposes of illustration and not limitation.

The lower edge of the first region R1 is immersed in analyte liquid in a Petri dish or other container as shown in FIG. 13. A first electrode E1 (positive or negative) resides in the analyte liquid while a second E2 (negative or positive) is in intimate physical and fluidic contact with the first region R1. The electrodes are connected to a conventional power supply or battery as shown to provide a desired voltage between the electrodes, providing an electric field gradient (represented by stiples) within the porous medium layer, which gradient is relatively weak at the lower edge of the first region R1 and which is relatively stronger proximate the upper electrode. This gradient is exploited for stationary-band focusing and accumulation of charged molecular species by setting a capillary-driven flow in opposition to the direction of net electrophoretic mobility of a given charged molecular species. For example, the liquid analyte flows upwardly via capillary action while the electric field repels oppositely-charged analyte molecules so that the analyte molecules of interest are separated and move to the second region R2 where the separated molecules optionally can be identified. For example, one or more reagent lines, spots or areas (not shown) can be placed at the second region R2 to react or interact with the molecules to this end to provide a detectable signal or color when analyzed by appropriate analysis techniques.

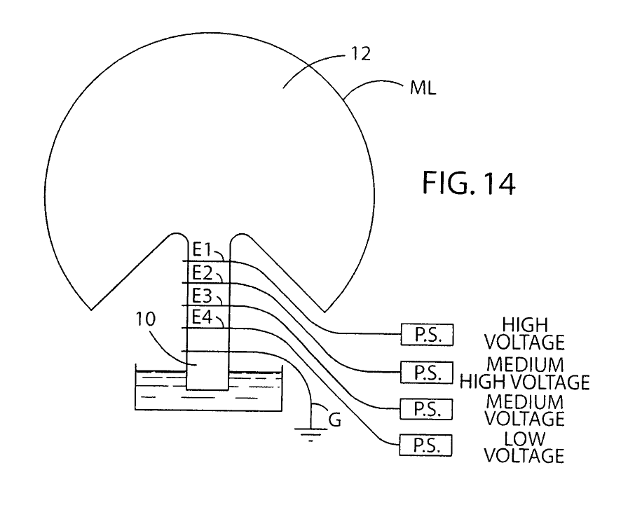

FIG. 14 shows another illustrative embodiment of the invention similar to that of FIG. 13 but differing in having a series of electrode wires E1, E2, E3, E4 and a ground wire G in intimate physical and fluidic contact with the first region R1 of the porous medium layer ML and spaced apart along the length thereof as shown. The electrodes E1-E4 are connected to respective power sources P.S. of high voltage, medium voltage and low voltage as shown to generate an electric field gradient within the porous medium layer.

The lower edge of the first region R1 is immersed in analyte liquid as shown. The liquid analyte flows upwardly via capillary action (see left hand arrow) while the electric field gradient repels oppositely-charged analyte molecules (right hand arrow) so that the analyte molecules of interest are separated and flow to the enlarged second region R2 of the porous medium layer ML where the separated molecules can be optionally identified as described above.

The above embodiments of FIGS. 12, 13, and 14, thereby provide electrophoretic molecule separation that includes, but is not limited to, electrochromatography, electric field gradient focusing and other electrically-based techniques.

The specific methods and devices described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention as defined in the appended claims.

### REFERENCES

1. Washburn E W. Phys Rev. 1921; 17:273-283.
2. O'Farrell B. “Pushing lateral flow to the limits”, in Emerging Technologies to Enable Quantitative Rapid Tests Workshop, Salt Lake City, Utah, Mar. 13-15, 2007.
3. Darcy H. Les Fontaines Publiques de la Ville de Dijon. Paris: Victor Dalmont, 1856.
4. Anonymous. Hi-Flow Plus Membranes. Billerica, Mass.: Millipore Corporation, undated.
5. Dullien, F. A. L. Porous Media: Fluid Transport and Pore Structure; Academic Press: New York, 1979; pp 170-174.
6. Schrage, R. W. A Theoretical Study of Interphase Mass Transfer; Columbia University Press: New York, 1953; p 36.
7. Warsinke, A. Anal. Bioanal. Chem. 2009, 393, 1393.
8. Bird, R. B.; Stewart, W. E., Lightfoot, E. N. Transport Phenomena, rev. 2nd ed.; John Wiley & Sons, Inc.: New York, 2007; p 189.
9. Williams, R. J. Coll. Interf Sci. 1981, 79, 287.
10. Fenton, E. M.; Mascarenas, M. R.; Lopez, G. P.; Sibbett, S. S. ACSAppl. Mater. Interfaces, 2009, 1, 124.
11. Weil, H. Coll. Polym. Sci. 1953, 132, 149.
12. Martinez, A. W.; Phillips, S. T.; Butte, M. J.; Whitesides, G. M. Angew. Chem. Int. Ed. 2007, 14, 1364.
13. Martinez, A. W.; Phillips, S. T.; Whitesides, G. M. Proc. Nail. Acad. Sci. USA 2008, 105, 19606.
14. Poole, C. F. J. Chromatogr. A 2003, 1000, 963.
15. Nyiredy, Sz. J. Chromatogr. A 2003, 1000, 985.
16. Nurok, D. J. Chromalogr. A 2004, 1044, 83.
17. Berezkin, V. G.; Litvin, E. F.; Balushkin, A. O.; Roiylo, .l. K.; Malinowska, 1. Chem. Anal. (Warsaw) 2005, 50, 349.
18. Novotny, A. L.; Nurok. D.; Replogle, R. W.; Hawkins, G. L.; Santini, R. E. Anal. Chem. 2006, 78, 2823.
19. Bakry, R.; Bonn, G. K.; Mair, D.; Svec, F. Anal. Chem. 2007, 79, 486.
20. Krishnamoorthy, S.; Makhijani, V.; Lei, M.; Giridharan, M.; Tisone, T. In Proceedings of the 2000 International Conference on Modeling and Simulation of Microsystems; Nano Science and Technology Institute Cambridge, Mass., 2000. [Online.] http://www.nsti.org/publications/MSM/2000/pdf/T42.08.pdf. [4 Mar. 2009, last date accessed.]
21. Hyvaluoma, 1.; Raiskinmiki, P.; Jdsberg, A.; Koponen, A.; Kataja, M.; Timonen, J. Phys. Rev. E 2006, 73, 036705-1.
22. Reyssat, M.; Sangne, L. Y.; van Nierop, E. A.; Stone, H. A. Europhys. Lett., in press.
23. Adamson, A. W. Physical Chemistry of Surfaces, 3rd ed.; John Wiley & Sons: New York, 1976; p 461.
24. Anonymous. Hi-Flow Plus Membranes. Billerica, Mass.: Millipore Corporation, undated.
25. Mansfield, M. In Emerging Technologies to Enable Quantitative Rapid Tests Workshop; Salt Lake City, Utah, 2007.
26. Anonymous. Rapid Lateral Flow Test Strips; Millipore Corporation: Billerica, Mass., 2006.
27. Berezkin, V. G.; Balushkin, A. O.; Tyaglov, B. V.; Rozhilo, Ya.; Malinovska, l. Dokl. Phys. Chem. (Eng.) 2004, 399, 287. Berezkin, V. G.; Nekhoroshev Russ. J. Phys. Chem. 2006. 80,955.
28. Mincsovics, E.; Ferenczi-Fodor, K., Tyihak, E. In Handbook of Thin-Layer Chromatography, 3rd ed.; Sherma, 1. and Fried, B., Eds.; Marcel Dekker, Inc.: New York, 2003; pp 175-205.
29. Nyiredy, S. In Handbook of Thin-Layer Chromatography, 3rd ed.; Sherma, J. and Fried, B., Eds.; Marcel Dekker, Inc.: New York, 2003; pp 307-338.
30. Slichter, C. S. In Annual Report of the United States Geological Survey to the Secretary of the Interior 1897-98; Government Printing Office: Washington, D.C., 1899, pp 295-350.
31. Muskat, M. Flow of Homogeneous Fluids, McGraw-Hill: New York, 1937 (reprint of 1982, International Human Resources Development Corporation: Atlanta, Ga.); pp 181-186.
32. Moon, P.; Spencer. D. E. Field Theory Handbook. 2nd ed., corrected 3rd printing; Springer-Verlag: Berlin, 1988; pp 17-19.
33. Galicyn, A. S.; Zhukovskii, A. N. In Analiticheskie. Chislennye i Analogovye Melody v Zadachakh Teploprovodnosti;
34. Lukovskii, I. A., Ed.; Naukova Dumka: Kiev, 1977; pp 18-28.
35. Galicyn, A. S.; Zhukovskii, A. N. In Analiticheskie, Chislennye i Analogovye Metody v Zadachakh Teploprovodnosti; Lukovskii, I. A., Ed.; Naukova Dumka: Kiev, 1977; pp 62-70.
36. Scheidigger, A. E. Physics of Flow through Porous Media, 3rd ed.; University of Toronto Press: Toronto, 1974; pp 75, 129.
37. Zhdanov, S. A.; Starov, V. M.; Sobolev, V. D.; Velarde M. G. J. Coll. Interf Sci. 2003, 264, 481.
38. Eames, I. W.; Marr, N. J.; Sabir, H. Int. J. Heat Mass Transfer 1997, 40, 2963.
39. University of Texas Health Science Center at San Antonio, Tex. 22 Feb. 2002, posting date of last revision. [Online.] Image Tool, version 3.0.http://ddsdx.uthscsa.edu/dig/127info.html. [16 Dec. 2002, last date accessed.]
40. Davison, S. M.; Sharp, K. V. In Proceedings of the COMSOl. Users Conference; COMSOL, Inc.: Burlington, Mass. 2006. [0 nline.] http://www.conisol.com/papers/1588/. [17 Feb. 2009, last date accessed.]

The above-listed references are incorporated herein by reference.

1. Lateral flow device comprising a two dimensionally shaped porous medium layer configured in two dimensions to provide near-constant velocity capillary-driven fluid flow in a region of the porous medium layer.

2. The device of claim 1 wherein the porous medium layer includes a first region connected to a relatively higher-pore volume second region in a manner to establish a near-constant capillary driven fluid flow in the first region once the fluid front passes from the first region to the second region.

3. The device of claim 2 wherein the second region has a larger area in a plan view than the first region of the porous medium layer for a given porous medium layer thickness and porosity.

4. The device of claim 2 wherein the second region provides a higher pore volume bed in cross section than the first region by virtue of the change in the two dimensional shape of the porous medium layer there for a given substantially constant thickness and porosity of the porous medium layer.

5. The device of claim 4 wherein the second region comprises an expanding two dimensional circular sector shape in plan view selected to provide a continuously increasing pore volume in cross-section relative to the advancing fluid front.

6. The device of claim 5 wherein the circular sector has a central angle greater than about 90° in plan view.

7. The device of claim 2 wherein the first region comprises an elongated region with a substantially constant cross-sectional area.

8. The device of claim 7 wherein the elongated region has a rectangular shape in plan view.

9. The device of claim 1 wherein the porous medium layer comprises nitrocellulose or paper.

10. The device of claim 1 including a fluid impervious substrate or layer adjacent the porous medium layer.

11. Combination of a lateral flow device comprising a two dimensionally shaped porous medium layer and one or more electrodes disposed relative to the porous medium layer in a manner to achieve molecule separation.

12. The combination of claim 11 wherein the electrodes are arranged relative to the porous medium layer to provide molecule separation by electrochromatography.

13. The combination of claim 11 wherein the electrodes are arranged relative to the porous medium layer to provide molecule separation by electric field gradient focusing.

14. The combination of claim 11 wherein the porous medium layer has an elongated region with a substantially constant cross-sectional area and at least one electrode is disposed adjacent the elongated region.

15. The combination of device of claim 14 wherein the elongated region has a rectangular shape in plan view.

16. The combination of claim 11 wherein the elongated region is connected to a second region in plan view of the porous medium layer wherein the second region has a larger area in plan view than the region.

17. The combination of claim 16 wherein the second region is circular or a circular sector in plan view.

18. The combination of claim 17 wherein the circular sector has a central angle greater than about 90° in plan view.

19. A method providing capillary-driven fluid flow, comprising wetting with fluid a first region of a two dimensionally shaped porous medium layer connected to a relatively higher-pore volume second region of the porous medium layer and establishing near-constant velocity capillary-driven fluid flow in the first region once the fluid front passes to the second region.

20. The method of claim 19 wherein the second region has an expanded or larger area in a plan view than the first region to provide a higher pore volume for a given porous medium layer thickness and porosity.

21. The method of claim 19 wherein the first region comprises an elongated region with a substantially constant cross-sectional area.

22. The method of claim 21 wherein the elongated region has a rectangular shape in plan view.

23. The method of claim 19 wherein the higher pore-volume region is a circular or a circular sector in plan view.

24. A method of separating different molecules, comprising providing a capillary-driven flow of fluid having different molecules in a first region of a two dimensionally shaped porous medium layer while providing an electric field proximate the region in a manner to achieve separation of the different molecules in a second region of the porous medium layer.

25. The method of claim 24 wherein molecule separation is provided by electrochromatography.

26. The method of claim 24 wherein molecule separation is provided by electric field gradient focusing.

26. The method of claim 24 wherein fluid flow in the elongated region is near-constant velocity capillary-driven fluid flow.
